(19) United States
(12) Patent Application Publication
(10) Pub. No.: US 2017/0171357 A1
(43) Pub. Date: Jun. 15, 2017

(54) APPARATUS AND METHOD FOR ASSISTING IN DOWNLOADING FILE SUCCESSFULLY

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Lei QIAO, Beijing (CN); Tengfei LI, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/243,418

(22) Filed: Aug. 22, 2016

Related U.S. Application Data
(63) Continuation of application No. PCT/CN2016/089513, filed on Jul. 10, 2016.

(30) Foreign Application Priority Data
Dec. 15, 2015 (CN) 2015109306318

(51) Int. Cl. H04L 29/06; H04L 29/12; H04L 29/08

(52) U.S. Cl. CPC H04L 67/42; H04L 67/06; H04L 61/6095

(57) ABSTRACT

An embodiment of the present disclosure provides an apparatus and a method for assisting in downloading file successfully, where the apparatus includes at least one processor and a memory communicably connected with the at least one processor for storing instructions executable by the at least one processor; wherein execution of the instructions by the at least one processor causes the at least one processor to: receive a file download request; send, in response to the file download request, the file download request by using a first domain name and a first download address among a plurality of download addresses pre-stored for the file; and send the file download request by using a second domain name and a second download address among the plurality of download addresses if the file is not successfully downloaded from the first download address within a predetermined period of time. By the above-described technical solutions, a reason for a downloading failure (for example, an invalid domain name and/or a fault of a certain download server) can be found at a fastest speed, and a different domain name and/or download address is used for requesting during retry, so that a file download request of a user can be responded to, and the file can be successfully downloaded, and the user can have a very good downloading experience.

### CROSS-REFERENCE TO RELATED APPLICATIONS

This application is a continuation of International Application No. PCT/CN2016/089513, with an international filing date of Jul. 10, 2016, which is based upon and claims priority to Chinese Patent Application No. 201510930631.8, filed on Dec. 15, 2015, the entire contents of all of which are incorporated herein by reference.

### TECHNICAL FIELD

The present disclosure relates to the field of information technologies, and specifically, to an apparatus and a method for assisting in downloading file successfully.

### BACKGROUND

An existing solution of file uploading and downloading is: a provider uploads a file available for users to download to a Content Delivery Network (CDN) server of a CDN, and the CDN server dispenses the file to all download servers in the CDN; and then, each of the download servers confirms receipt of the file with the CDN server and feeds back a download address of the file (that is, an address of the download server) thereto, so that a client may download the file from the download server by using the download address.

However, the downloading solution of prior art has the following disadvantages which may result in that a client cannot download an original file from a CDN node:

1) when a client downloads a file, it is impossible to ensure that a download address used is 100% valid, because there are so many download servers that it is hard to ensure each of the download servers capable of running normally, and if there is a certain download server unable to run normally, the client will fail to download the file from the download server;

2) there exists a situation of domain name hijacking which is correlated with a provider where the provider may have not filed the domain name and have not added it into a list of legal domain names (for example, the domain name of Google inaccessible in mainland China currently), so that using the domain name to download from a download server may also lead to a downloading failure.

### SUMMARY

An objective of some embodiments of the present disclosure is to provide an apparatus and a method for assisting in downloading file successfully, capable of effectively solving the above problems of file downloading failure caused by an invalid domain name or a fault of a certain download server.

To achieve the above objective, an embodiment of the present disclosure provides an apparatus for assisting in downloading file successfully, where the apparatus includes at least one processor and a memory communicably connected with the at least one processor for storing instructions executable by the at least one processor; wherein execution of the instructions by the at least one processor causes the at least one processor to: receive a file download request; and send, in response to the file download request, a file download request by using a first domain name and a first download address among a plurality of download addresses pre-stored for the file; and send the file download request by using a second domain name and a second download address among the plurality of download addresses if the file is not successfully downloaded from the first download address within a predetermined period of time.

Another embodiment of the present disclosure also provides a method for assisting in downloading file successfully, where the method includes: receiving a file download request; sending, in response to the file download request, the file download request by using a first domain name and a first download address among a plurality of download addresses pre-stored for the file; and sending the file download request by using a second domain name and a second download address among the plurality of download addresses if the file is not successfully downloaded from the first download address within a predetermined period of time.

According to an embodiment of the present disclosure, there is provided with a non-transitory computer-readable storage medium storing executable instructions that, when executed by an electronic apparatus, cause the electronic apparatus to perform an above disclosed method.

By the above-described technical solutions, a reason for a downloading failure (for example, an invalid domain name and/or a fault of a certain download server) can be found at a fastest speed, and a different domain name and/or download address is used for requesting during retry, so that a file download request of a user can be responded to, and the file can be successfully downloaded, and the user can have a very good downloading experience.

The other features and advantages of the present disclosure are described in detail in the detailed description below.

### BRIEF DESCRIPTION OF THE DRAWINGS

The accompanying drawings are provided to facilitate understanding of the present disclosure, and constitute a part of the specification, and are used to interpret the present disclosure together with the detailed description below, but are not intended to limit the present disclosure. In the accompanying drawings:

FIG. 1 is a schematic structural diagram of an environment in which an apparatus for assisting in downloading file successfully is implemented according to some embodiments of the present disclosure;

FIG. 2 is a schematic structural diagram of an apparatus for assisting in downloading file successfully according to some embodiments of the present disclosure;

FIG. 3 is a work flow chart of an apparatus for assisting in downloading file successfully according to some embodiments of the present disclosure; and,

FIG. 4 is a schematic hardware diagram of an electronic apparatus for performing a method of assisting in downloading file successfully according to an embodiment of the present disclosure.

### DESCRIPTION OF REFERENTIAL NUMERALS

| | | | |
|---|---|---|---|
| 100 | Client | 110 | Receiving device |
| 120 | Processing device | 200 | CDN server |
| 210-240 | Download server | 300 | Internet |

### DETAILED DESCRIPTION

The specific implementation manners of some embodiments of the present disclosure will be described in detail below in combination with the accompanying drawings. It should be understood that the specific implementation manners described herein are used to describe and interpret the present disclosure only, and are not intended to limit the present disclosure.

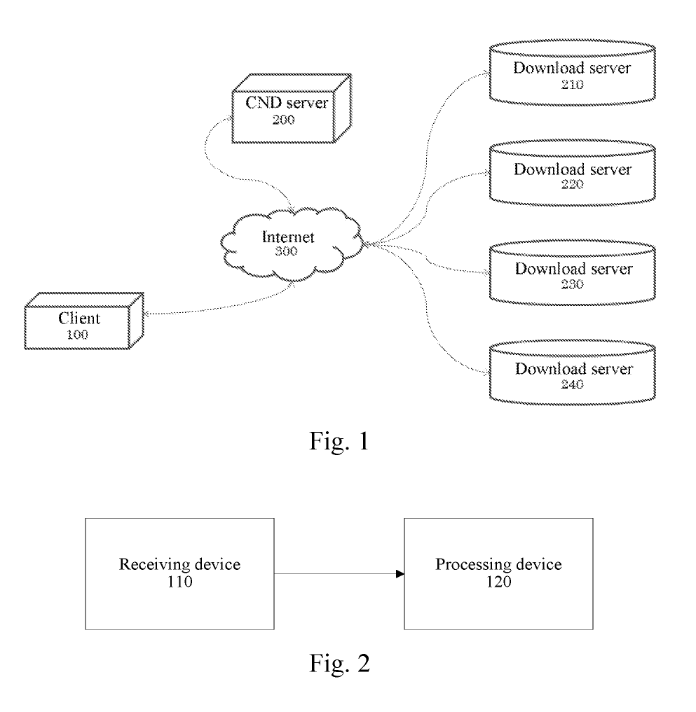

FIG. 1 is a schematic structural diagram of an environment in which an apparatus for assisting in downloading file successfully is implemented according to an embodiment of the present disclosure. A provider uploads a file available for users to download to a CDN server 200, and the CDN server 200 dispenses the file to all download servers 210-240 in the CDN; and then, each of the download servers confirms receipt of the file with the CDN server 200 and feeds back a download address of the file (that is, an address of the download server 210-240) thereto. When a client 100 accesses a download page of the file, the CDN server 200 may determine, according to an IP address of the client 100, a download server most suitable for the client 100 to download the file therefrom, and send an address of the download server to the client 100. For example, the CDN server 200 may determine, according to the IP address of the client 100, a geographic location where the client 100 is located, and allocate a download server at or near the geographic location according to the geographic location. For example, for a client in Nanjing area, a download server in local Nanjing or a download server in Shanghai may be allocated for the client. Certainly, the present disclosure is not limited thereto. If a download server other than the one at or near the geographic location of the client can provide a better downloading speed, the CDN server 200 also may send a download address of the download server to the client. Generally, the CDN server 200 may send a plurality of download addresses of download servers to the client 100. The present disclosure is described by using four download addresses as an example. After receiving a plurality of download addresses from the CDN server 200, the client 100 may store the plurality of download addresses for use when the client 100 receives a formal file download request from a user.

FIG. 2 is a schematic structural diagram of an apparatus for assisting in downloading file successfully according to an embodiment of the present disclosure. The apparatus may be implemented in the environment shown in FIG. 1, and specifically may be implemented in the client shown in FIG. 1. As shown in FIG. 2, the present disclosure provides an apparatus for assisting successful file downloading. The apparatus includes: a receiving device 110 configured to receive a file download request; and a processing device 120 configured to execute the following operations: sending, in response to the file download request, the file download request by using a first domain name (for example, www.xxx.com) and a first download address (for example, an address of the download server 210 in FIG. 1) among a plurality of download addresses pre-stored for the file; and sending the file download request by using a second domain name (for example, www.xxx.cn) and a second download address (for example, an address of the download server 220 in FIG. 1) among the plurality of download addresses if the file is not successfully downloaded from the first download address within a predetermined period of time. The domain name and the download address described herein are used for addressing a corresponding download server and are information necessary for a client to access the download server.

Generally, the problems related to file downloading facing most clients can be solved by changing a domain name and changing a download address. However, in some cases, a failure of a client to access a download server may be because both a first domain name and a second domain name are invalid. At this time, a processing device may send the file download request by directly using an IP address (for example, 1.2.0.1) corresponding to the first domain name or the second domain name and the second download address. In this way, the problem of a file downloading failure caused by a domain name resolution failure can be thoroughly solved.

If downloading still fails by using the IP and the second download address as described above, indicating a possible result from shutdown of the download servers 210 and 220, the processing device may send the file download request by using the first domain name (for example, www.xxx.com) and a third download address (for example, an address of the download server 230 in FIG. 1) among the plurality of download addresses. The processing device may further be configured to send the file download request by using the second domain name (for example, www.xxx.cn) and a fourth download address (for example, an address of the download server 240 in FIG. 1) among the plurality of download addresses if the file is not successfully downloaded from the third download address within a predetermined period of time. The processing device may further be configured to send the file download request by using the IP address (for example, 1.2.0.1) corresponding to the first domain name or the second domain name and the fourth download address if the file is not successfully downloaded from the fourth download address within a predetermined period of time.

How to download a file by using the solution of the present disclosure with respect to a scenario in which the download servers 210 and 220 are shut down and the download servers 230 and 240 are running is explained and described in the table below.

| Step | Domain name and download address used | Result |
|---|---|---|
| 1 | first domain name (www.xxx.com); and | fail |
| | first download address (that is, the address of the | |
| | download server 210) | |
| 2 | second domain name (www.xxx.cn); and | fail |
| | second download address (that is, the address of the | |
| | download server 220) | |
| 3 | IP (1.2.0.1); and | fail |
| | second download address (that is, the address of the | |
| | download server 220) | |
| 4 | first domain name (www.xxx.com); and | succeed |
| | third download address (that is, the address of the | |
| | download server 230) | |
| 5 | second domain name (www.xxx.cn); and | succeed |
| | fourth download address (that is, the address of the | |
| | download server 240) | |
| 6 | IP (1.2.0.1); and | succeed |
| | fourth download address (that is, the address of the | |
| | download server 240) | |

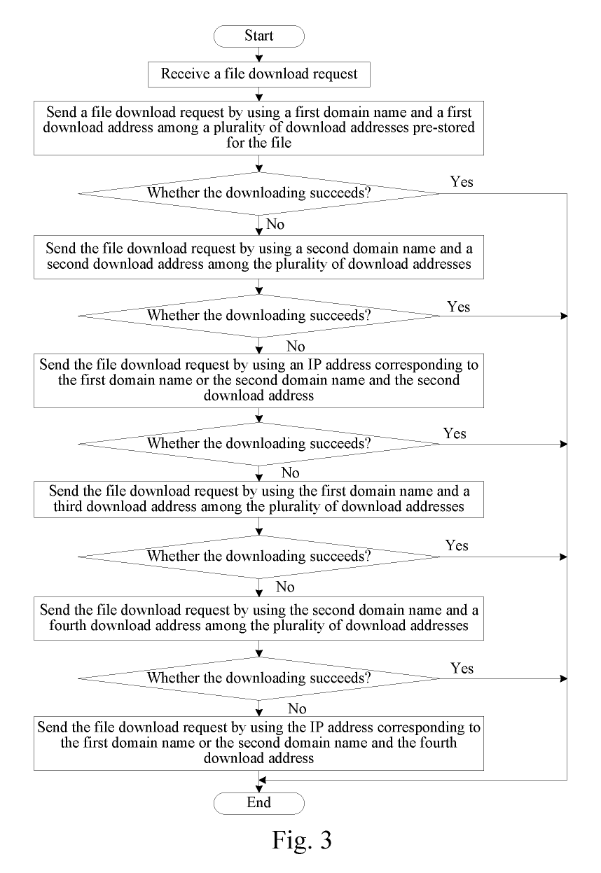

FIG. 3 is a work flow chart of an apparatus for assisting in downloading file successfully according to an embodiment of the present disclosure. As shown in FIG. 3, correspondingly, an embodiment of the present disclosure also provides a method for assisting in downloading file successfully. The method includes: receiving a file download request; sending, in response to the file download request, the file download request by using a first domain name and a first download address among a plurality of download addresses pre-stored for the file; and sending the file download request by using a second domain name and a second download address among the plurality of download addresses if the file is not successfully downloaded from the first download address within a predetermined period of time. Specific details and benefits of the method may be referred to the foregoing detailed description with respect to the apparatus for assisting file downloading provided by the present disclosure, which are not repeated herein.

By the above-described technical solutions, a reason for a downloading failure (for example, an invalid domain name and/or a fault of a certain download server) can be found at a fastest speed, and a different domain name and/or download address is used for requesting during retry, so that a file download request of a user can be responded to, and the file can be successfully downloaded, and the user can have a very good downloading experience.

According to an embodiment of the present disclosure, there is provided with a non-transitory computer-readable storage medium storing executable instructions that, when executed by an electronic apparatus, cause the electronic apparatus to perform any one of above disclosed methods.

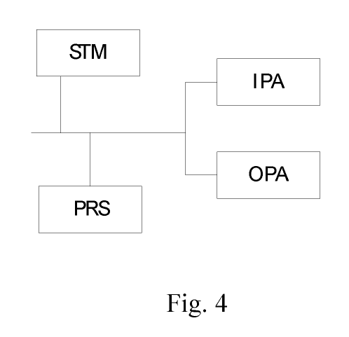

FIG. 4 illustrates a schematic hardware diagram of an electronic apparatus for performing any one of above disclosed methods. According to FIG. 4, the electronic apparatus includes one or more processors PRS and a storage medium STM. FIG. 4 shows one processor PRS as an example.

The electronic apparatus can further include an input apparatus IPA and an output apparatus OPA.

The one or more processors PRS, storage medium STM and output apparatus OPA may be connected by a bus or other means. FIG. 4 shows a bus as an example for connection.

Storage medium STM is a non-transitory computer-readable medium for storing a non-transitory software program, a non-transitory computer-readable program and module, for example the program instructions/module for performing an above described method (e.g. processing device 120 shown in FIG. 2). The processor PRS can operate the various functions and data processing of a server to perform a method described in the above embodiments by executing non-transitory software programs, instructions and modules stored in the storage medium STM.

The storage medium STM can include a program storage area and a data storage area. Among them, the program storage area may store operation system, application programs of at least one function; the data storage area may store generated data during operation of the electronic apparatus for performing the method described in the above embodiments. In addition, the storage medium STM may include a high speed random access memory, and a non-transitory storage medium, for example a magnetic storage device (e.g., hard disk, floppy disk, and magnetic strip), a flash memory device (e.g., card, stick, key drive) or other non-transitory solid state storage device. In some embodiments, the storage medium STM may include a storage medium that is remote to the processor PRS. The remote storage medium may be connected to the electronic apparatus for performing any of the above methods by a network. The examples of such as network include but not limited to Internet, enterprise intranet, local area network, mobile telecommunication network and a combination thereof.

The input apparatus IPA can receive input number or byte information, and can generate input key information relating to user setting and functional control of the electronic apparatus for performing the method described in the above embodiments. The output apparatus OPA may include a display device such as a display screen.

The one or more modules stored in the storage medium STM that, when executed by the one or more processors PRS, can perform any of the above described methods.

The above products can perform any of the above described methods, and have corresponding functional modules and effects. Details that are not disclosed in this embodiment can be understood by reference to the above method embodiments of the present disclosure.

An electronic apparatus of the present disclosure can exist in a varied form and includes but not limited to:
(1) A mobile communication device which is capable of performing mobile communication function and having a main purpose for audio or data communication. Such a mobile communication device includes: a smart phone (e.g. iPhone), a multimedia phone, a functional mobile phone and a low-end mobile phone etc.
(2) A super-mobile personal computer which belongs to the field of a personal computer and has calculation and processing functions, and in general can access to a mobile network. Such a terminal device includes: a PDA, a MID and a UMPC etc., for example iPad.
(3) A portable entertainment device which is capable of displaying and playing multimedia content. Such a device includes: an audio player, a video player (e.g. iPod), a handheld game console, an electronic book, a smart toy and a portable automotive navigation device.
(4) A server which can provide calculation service and can include a processor, a hard disk, a memory, a system bus etc. Such a server is similar to a general computer in terms of a computer structure, but is necessary to provide reliable service, which therefore requires a higher standard in certain aspects such as data processing, stability, reliability, security and compatibility and manageability etc.
(5) Other electronic apparatus that is capable of data exchange.

The above described apparatus embodiments are for illustration purpose only, in which modules/units that are described above as separate elements may be physically separate or not separate and modules/units that are described above as display elements may be or may not be a physical unit, i.e. in a same location or in various distributed network units. The skilled person in this field can understand that it is possible to select some or all of the units or modules to achieve the purpose of the embodiment.

Preferable implementation manners of some embodiments of the present disclosure are described in detail above in combination with the accompanying drawings. However, the present disclosure is not limited to the specific details of the above-described implementation manners. Within the scope of the technical concept of the disclosure, multiple simple variations can be made to the technical solutions of some embodiments of the present disclosure, and these simple variations all fall within the protection scope of the present disclosure.

In addition, it should be noted that the various specific technical features described above in the detailed description can be combined in any suitable manners in the case of no contradiction. To avoid unnecessary repetition, the various possible combination manners are not described additionally in the present disclosure.

In addition, any combination of the various implementation manners of the present disclosure may also be possible and should also be considered as the disclosure of the present disclosure as long as it does not depart from the spirit of the present disclosure.

1. An apparatus for assisting in downloading file successfully, comprising at least one processor and a memory communicably connected with the at least one processor for storing instructions executable by the at least one processor;
wherein execution of the instructions by the at least one processor causes the at least one processor to:
receive a file download request; and
send, in response to the file download request, the file download request by using a first domain name and a first download address among a plurality of download addresses pre-stored for the file; and
send the file download request by using a second domain name and a second download address among the plurality of download addresses if the file is not successfully downloaded from the first download address within a predetermined period of time.

2. The apparatus according to claim 1, wherein the at least one processor is further caused to send the file download request by using an IP address corresponding to the first domain name or the second domain name and the second download address if the file is not successfully downloaded from the second download address within a predetermined period of time.

3. The apparatus according to claim 2, wherein the at least one processor is further caused to send the file download request by using the first domain name and a third download address among the plurality of download addresses if the file is not successfully downloaded from the second download address within the predetermined period of time.

4. The apparatus according to claim 3, wherein the at least one processor is further caused to send the file download request by using the second domain name and a fourth download address among the plurality of download addresses if the file is not successfully downloaded from the third download address within a predetermined period of time.

5. The apparatus according to claim 4, wherein the at least one processor is further caused to send the file download request by using the IP address corresponding to the first domain name or the second domain name and the fourth download address if the file is not successfully downloaded from the fourth download address within a predetermined period of time.

6. A method for assisting in downloading file successfully, comprising:
receiving a file download request; and
sending, in response to the file download request, the file download request by using a first domain name and a first download address among a plurality of download addresses pre-stored for the file; and
sending the file download request by using the second domain name and a second download address among the plurality of download addresses if the file is not successfully downloaded from the first download address within a predetermined period of time.

7. The method according to claim 6, wherein the method further comprises:
sending the file download request by using an IP address corresponding to the first domain name or the second domain name and the second download address if the file is not successfully downloaded from the second download address within a predetermined period of time.

8. The method according to claim 7, wherein the method further comprises:
sending the file download request by using the first domain name and a third download address among the plurality of download addresses if the file is not successfully downloaded from the second download address within the predetermined period of time.

9. The method according to claim 8, wherein the method further comprises:
sending the file download request by using the second domain name and a fourth download address among the plurality of download addresses if the file is not successfully downloaded from the third download address within a predetermined period of time.

10. The method according to claim 9, wherein the method further comprises:
sending the file download request by using the IP address corresponding to the first domain name or the second domain name and the fourth download address if the file is not successfully downloaded from the fourth download address within a predetermined period of time.

11. A non-transitory computer-readable storage medium storing executable instructions that, when executed by an electronic apparatus, cause the electronic apparatus to:
send, in response to a file download request received by the electronic apparatus, the file download request by using a first domain name and a first download address among a plurality of download addresses pre-stored for the file; and
send the file download request by using the second domain name and a second download address among the plurality of download addresses if the file is not successfully downloaded from the first download address within a predetermined period of time.

12. The storage medium according to claim 11, wherein the storage medium further comprises instructions to:
send the file download request by using an IP address corresponding to the first domain name or the second domain name and the second download address if the file is not successfully downloaded from the second download address within a predetermined period of time.

13. The storage medium according to claim 12, wherein the storage medium further comprises instructions to:
send the file download request by using the first domain name and a third download address among the plurality of download addresses if the file is not successfully downloaded from the second download address within the predetermined period of time.

14. The storage medium according to claim 13, wherein the storage medium further comprises instructions to:
send the file download request by using the second domain name and a fourth download address among the plurality of download addresses if the file is not successfully downloaded from the third download address within a predetermined period of time.

15. The storage medium according to claim 14, wherein the storage medium further comprises instructions to:
send the file download request by using the IP address corresponding to the first domain name or the second domain name and the fourth download address if the file is not successfully downloaded from the fourth download address within a predetermined period of time.
